(19) United States
(12) Patent Application Publication
(10) Pub. No.: US 2016/0266647 A1
(43) Pub. Date: Sep. 15, 2016

(54) SYSTEM FOR SWITCHING BETWEEN MODES OF INPUT IN RESPONSE TO DETECTED MOTIONS

(71) Applicant: STMicroelectronics SA, Montrouge (FR)

(72) Inventor: Jocelyn Leheup, Asnieres-sur-Seine (FR)

(73) Assignee: STMicroelectronics SA, Montrouge (FR)

(21) Appl. No.: 14/641,852

(22) Filed: Mar. 9, 2015

(51) Int. Cl. G06F 3/01; G06F 3/0484; G06F 3/0481; G01S 17/88

(52) U.S. Cl. CPC G06F 3/017; G01S 17/88; G06F 3/0484; G06F 3/04815; G06F 2203/04808

(57) ABSTRACT

A system includes a time of flight (TOF) ranging sensor, and a processor coupled to the TOF ranging sensor. The processor executes an operating system commanded by an input sub-program thereof. Execution of the input sub-program causes the processor to interpret command motions sensed via the TOF ranging sensor in one of a plurality of command interpretation modes, generate commands for the operating system based on the interpreted command motions, and switch among the plurality of command interpretation modes based upon sensing of a mode switch motion via the TOF ranging sensor.

### TECHNICAL FIELD

This disclosure relates to the field of motion sensing, and more particularly, the use of motion sensing to switch a system between modes of input.

### BACKGROUND

Early computing systems utilized devices such as keyboards and mice for accepting user input. As technology advanced, computing systems expanded to utilize resistive and capacitive touch sensitive screens for accepting user input. Presently, computing systems are now starting to utilize motion sensors for accepting user input.

There are multiple types of user input that may be accepted by a computing system. For example, one type of user input may involve the changing or selecting of system options, such as the changing of system audio volume, or returning to a home screen. Another type of user input may involve the moving of a mouse pointer, and the election of items on the display with the mouse pointer.

While computing systems exist that accept user selection for both types of this user input via motion sensors, these systems rely upon contact between the user and the system, for example via a touch screen, to change between these types of user input. This may be time consuming and undesirable to users because it requires contact with the computing system, when the aim of using motion sensors to accept user input is to eliminate that contact requirement.

Therefore, further advances in computing systems utilizing motion sensors is desirable.

### SUMMARY

A system that addresses the above issues includes at least one time of flight (TOF) ranging sensor, and a processor coupled to the at least one TOF ranging sensor. The processor is configured to execute an operating system commanded by an input sub-program thereof. Execution of the input sub-program causes the processor to interpret command motions sensed via the at least one TOF ranging sensor in one of a plurality of command interpretation modes, generate commands for the operating system based on the interpreted command motions, and switch among the plurality of command interpretation modes based upon sensing of a mode switch motion via the at least one TOF ranging sensor.

The first command interpretation mode may be a position tracking mode. When in the position tracking mode, the commands for the operating system may command the operating system as if the commands were received from an input device. When in the position tracking mode, the commands may command the operating system to move a mouse pointer on a display.

The second command interpretation mode may be an action mode. When in the action mode, the commands for the operating system may command the operation system as if the commands were received from the input device. When in the action mode, the commands may command the operating system to register a mouse click.

A given command motion and the mode switch motion may be substantially similar motions performed at respectively different distances from the at least one TOF ranging sensor.

The at least one TOF ranging sensor may include a plurality of TOF ranging sensors configured to, in operation, measure distances to an object. The processor may be further configured to receive indications of the measured distances from the plurality of TOF ranging sensors and determine at least one inclination of the object in relation to at least one direction based on the received indications of the measured distances. The processor may sense the command motions based upon the determined at least one inclination.

The processor may receive indications of the measured distances from at least one TOF ranging sensor of the plurality thereof that defines a first direction, as a distance to the object in the first direction, and from at least one TOF ranging sensor of the plurality thereof that defines a second direction different than the first direction, as a distance to the object in the second direction. The processor may determine a first inclination based upon the received indication of the distance to the object in the first direction, and a second inclination based upon the received indication of the distance to the object in the second direction. The processor may sense the command motions based upon the determined first and second inclinations.

The mode switch motion may include movement of the hand in a gesture. The gesture may be a clockwise or counterclockwise or semicircular motion.

The mode switch motion may be movement of the hand toward the at least one TOF ranging sensor such that the hand moves within a threshold distance from the at least one TOF ranging sensor, or movement of the hand away from the at least one TOF ranging sensor such that the hand moves out of a threshold distance from the at least one TOF ranging sensor.

The mode switch motion may be movement of the hand from outside the sensing range of the at least one TOF ranging sensor to within the sensing range of the at least one TOF ranging sensor from a given direction.

The mode switch motion may include stabilization of the hand a given distance from the at least one TOF ranging sensor for a given period of time.

The sub-program may include a software implemented input device for the operating system.

Another aspect is directed to a system including at least one visual based motion sensor, and a processor coupled to the at least one visual based motion sensor. The processor is configured to execute a program causing the processor to detect a first command motion performed by a hand within sensing range of the at least one visual based motion sensor, generate a first command based upon interpreting the first command motion in a first motion interpretation mode, detect a mode switch motion performed by the hand within sensing range of the at least one visual based motion sensor, switch from the first motion interpretation mode to a second motion interpretation mode based upon the mode switch motion, detect a second command motion performed by the hand within sensing range of the at least one visual based motion sensor, and generate a second command based upon interpreting the motion in a second motion recognition mode.

A method aspect includes sensing motions performed by a hand within sensing range of at least one visual based sensor, using a processor coupled to the at least one visual based sensor. The method also includes generating commands for an operating system of the processor by interpreting the motions in a first motion interpretation mode or a second motion interpretation mode, based upon the motions being command motions, using the processor. The method further includes switching between the first motion interpretation mode and the second interpretation mode, based upon the motions being mode switching motions, using the processor.

### BRIEF DESCRIPTION OF THE DRAWINGS

FIG. 1 is a block diagram of a system on which the techniques described herein may be performed.

FIG. 2 is a flowchart of operation of the system of FIG. 1 for switching between modes of input in response to detected motions.

FIG. 3 schematically represents a lateral view of distance sensors which may be used for the motion detection performed by the device of FIG. 1.

FIG. 4 schematically represents a lateral view of distance sensors which may be used for the motion detection performed by the device of FIG. 1, in which the object being detected is at a different position than in FIG. 3.

### DETAILED DESCRIPTION

One or more embodiments of communication systems in accordance with the principles of the present invention will be described below. These described embodiments are only examples of techniques to implement the invention, as defined solely by the attached claims. Additionally, in an effort to provide a focused description of the invention and the principles of the invention, irrelevant features of an actual implementation may not be described in the specification.

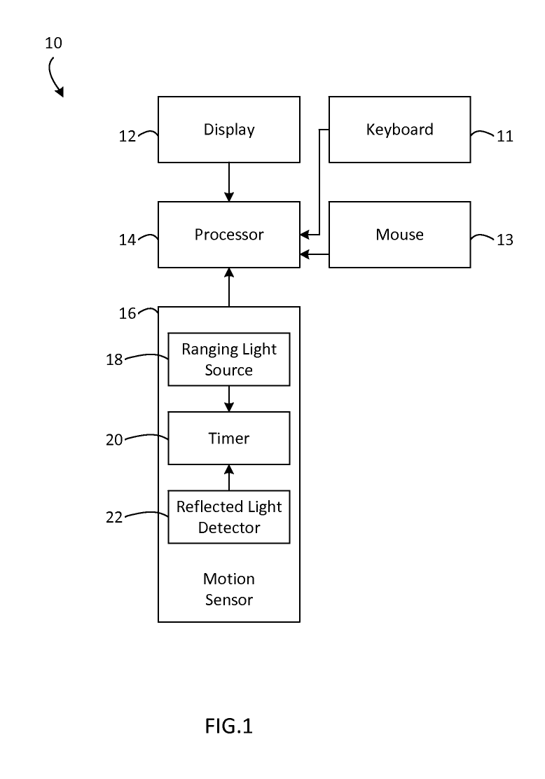

The disclosure herein relates to methods of operation of a system. The system itself will first be described with reference to FIG. 1. The system 10 is a computing system or electronic device, such as a desktop computer, laptop computer, tablet, or smartphone. The system 10 includes a processor 14 having a display 12, keyboard 11, and mouse 13 coupled thereto. The display 12 may in some instances be a touch sensitive display and therefore also serve as an input device. A motion sensor 16 is also coupled to the processor 14 for providing user input thereto. The motion sensor 16 is a time of flight ranging system, and includes a ranging light source 18 and reflected light detector 22 coupled to a timer 20. In operation, the ranging light source 18 emits light, and the reflected light detector 22 detects the light when it has reflected off an object and traveled back to the motion sensor 16. By measuring the time elapsed between emission of the light by the ranging light source 18 and the detection of the reflected light by the reflected light detector 22, since the speed of light is known and constant, the timer 20 is able to determine the distance between the motion sensor 16 and the object off which the light has reflected. Although one motion sensor 16 is shown, it should be appreciated that the system 10 may include any number of motion sensors 16.

In some applications, there may be multiple motion sensors 16, with each sensor coupled to the processor 14. In other applications, there may be multiple motion sensors 16 coupled to a sensor hub, and the sensor hub may be coupled to the processor 14.

The processor 14 is executing an operation system, such as Windows, OS X, iOS, or Android. The operation system includes a variety of sub-programs, such as input device sub-programs. The input device sub-programs serve to scan input devices, such as the keyboard 11 and mouse 13, and touch sensitive displays 12. The sub-program scans the input device and determines a command input by the user to the input device, and returns that command to the operation system for execution thereof. These commands may be direct commands to the operation system, such as commands to change the system volume, or return to a system home screen. Alternatively, these commands may be commands that control a mouse pointer (i.e. moving the pointer), which in turn is used to issue commands to the system (i.e. executing a “left click” or “right click” over a clickable area on the display 12).

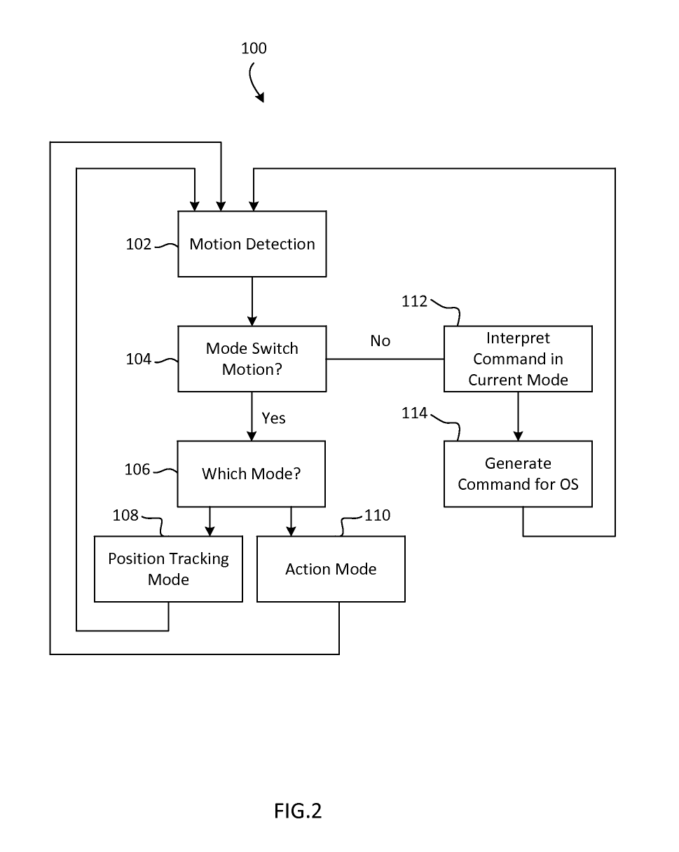

With additional reference to the flowchart 100 of FIG. 2, operation of the system 10 is now described. Here, the motion sensor 16 is treated as an input device, and has its own input device sub-program being executed by the processor 14 within the operating system. The processor 14, via the motion sensor 16, performs motion detection (Block 102). When a motion is detected within the sensing range of the motion sensor 16, the processor 14 analyzes the raw data output from the motion sensor 16 in order to determine whether the motion made was a recognized mode switch motion (Block 104).

If the processor 14 determines that the motion is not recognized command motion, it then attempts to interpret the command in the currently selected motion interpretation mode (Block 112). As explained above, there are multiple types of command inputs, which can generally be categorized into commands relating to position tracking (i.e. control of a mouse pointer), and commands related to actions (i.e. generally unrelated to control of the mouse pointer, such as volume controls, a switch to a home screen, or a mouse click). So as to provide for accurate interpretation of motions, it is helpful for the processor 14 to have multiple modes of motion interpretation, for example one mode where motions are interpreted as commands to move the mouse pointer, another mode for actions (i.e. click of the mouse button), and another mode where motions are interpreted as direct commands to the system (i.e. change the system volume or return to a home screen), and for the processor 14 to switch between these motion interpretation modes on the fly.

Upon successfully interpreting the command in the currently selected motion interpretation mode, the processor 14 then generates the command to the operating system corresponding to the interpretation of the command motion under the currently selected motion interpretation mode (Block 114). This generation of the command may be performed by the processor 14 during execution of the input-device subprogram, or may be performed by the processor during execution of the operating system after receiving input data from the sensor 16 via the input-device subprogram. The processor 14 then returns to performing motion detection (Block 102).

If, however, a mode switch motion was detected (at Block 104), the processor 14 then interprets the mode switch motion to determine which motion interpretation mode it should switch to (Block 106). Shown as an example here is a case where the mode switch motion is interpreted to result in the switching to a position tracking mode (Block 108) in which motions are interpreted as commands to move the mouse pointer. The processor 14 then returns to performing motion detection (Block 102). Also shown as an example is a case where the mode switch motion is interpreted to result in the switching to an action mode (Block 110) in which motions are interpreted as actions of a mouse (i.e. left click, right click, or scroll of a scroll button), The processor 14 then returns to performing motion detection (Block 102).

Those of skill in the art will recognize that any mode switch motion may be used. For example, the motion switch motion may be movement of the hand in a gesture, such as a clockwise or counterclockwise circular or semicircular motion. In addition, the mode switch motion may be movement of the hand toward the sensor 16 such that the hand moves within a threshold distance of the sensor (i.e. the hand is initially in the sensing range of the sensor 16 but is more than X feet from the sensor, and is then moved to less than X feet from the sensor). Similarly, the mode switch motion may be movement of the hand away from the sensor 16 such that the hand moves out of a threshold distance from the sensor (i.e. the hand is initially in the sensing range of the sensor 16 and less than X feet from the sensor, and is then moved to more than X feet from the sensor).

Another example mode switch motion may be movement of the hand from outside the sensing range of the sensor 16 to inside the sensing range of the sensor 16, or movement of the hand from inside the sensing range of the sensor 16 to outside the sensing range of the sensor 16. A further example mode switch motion may be the stabilization and holding still of the hand a given distance from the sensor 16 for a given period of time.

It should be appreciated that the command motions may also take any form, and may also be gestures. In addition, it should be understood that a given command motion may be the same as a given mode switch motion, with the difference being the distance from the sensor 16 at which the motion is performed.

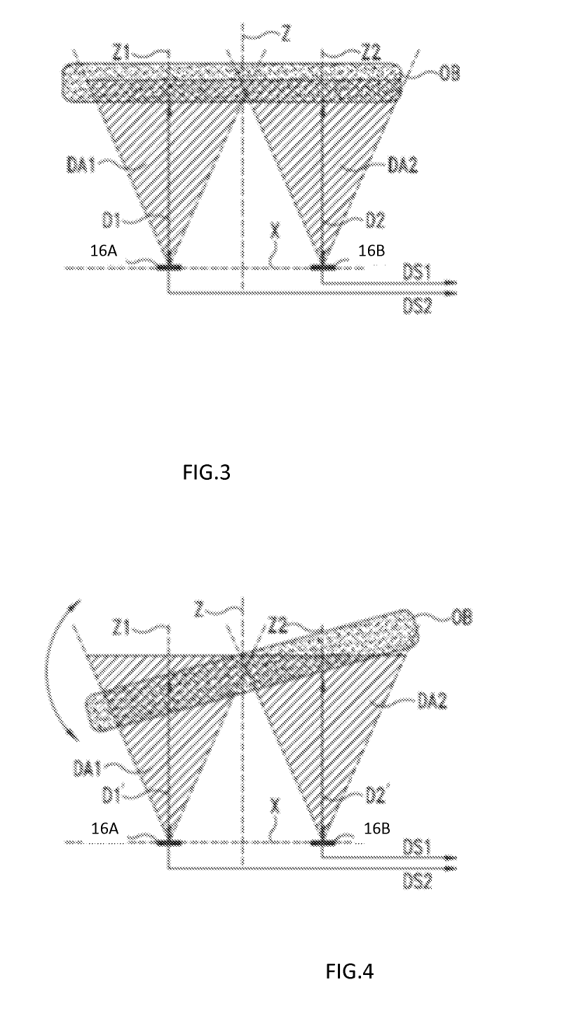

Details of the motion detection will now be given with additional reference to FIG. 3. Here, there are two sensors 16A, 16B used to detect the movement of the user's hand in a detection field. The movement to be detected is for example a change in the inclination of the user's hand placed in the detection field. In operation, each sensor 16A, 16B has a detection field DA1, DA2 represented in cone shape on the figures, generally extending along a symmetry axis of revolution corresponding to a detection axis Z1, Z2. The detection field of the device 10 of FIG. 1 is thus formed by the association of the fields DA1, DA2. The axes Z1, Z2 are substantially parallel to a measurement direction Z, and spaced out from each other by a distance between a minimum value sufficient to detect an inclination of the user's hand with sufficient accuracy and a maximum value generally lower than the size of the user's hand. An inclination of the user's hand may be determined if the user's hand is simultaneously in the two detection fields DA1, DA2.

Each of the sensors 16A, 16B supplies the processor 14 of FIG. 1 with a detection signal DS1, DS2 representative of the distance D1, D1′, D2, D2′ along the detection axis Z1, Z2 between the sensors 16A, 16B and an object OB (the user's hand) present in the detection field DA1-DA2. The processor 14 is configured to determine distance measurements to the object OB detected by the sensors 16A, 16B based upon the detection signals DS1, DS2. These may be in turn used by the processor 14 to assess an inclination of the user's name.

In FIG. 1, the distances D1, D2 between the sensors 16A, 16B and the object OB are substantially equal, indicating that one face of the object OB opposite the sensors 16A, 16B is substantially parallel to an axis X linking the sensors 16A, 16B. In FIG. 2, the distance D1′ between the sensor 16A and the object OB is lower than the distance D2′ between the sensor 16B and the object OB. The result is that the object OB is in an inclined position in relation to the axis X.

The processor 14 can use the inclination, distances D1, D′, D2, D2′, change in inclination over time, changes in distances D1, D′, D2, D2′ over time, rate of change of inclination, and/or rate of change of distances D1, D′, D2, D2′ to determine the motions of the user's hand, which are then in turn used to detect/interpret the command motions and mode switch motions.

Each distance sensor 16A, 16B may comprise one or more SPAD-type diodes, associated with a common pulsed light source. According to one embodiment, each distance sensor 16A, 16B comprises a pulsed light source and several SPAD diodes spread over several rows and several columns, for example 6 rows and 7 columns. Each distance sensor may be similar to those described in the applications FR 2,984,522 (US Pub. No. 2013/0153754) or FR 2,985,570 (US Pub. No. 2013/0175435) filed by the Applicant, the contents of which are hereby incorporated by reference in their entirety. If each sensor 16A, 16B comprises its own pulsed light source, provision may be made to synchronize the light sources of the sensors 16A, 16B to prevent them from interfering with the photodiodes of the other sensors. The range of distances detectable can extend from a few centimeters to about thirty centimeters from the SPAD diodes. It will be understood that other types of distance sensors 16A, 16B may be employed. Each distance sensor 16A, 16B may comprise one or more photodiodes associated with a pulsed light source which may be common to both distance sensors 16A, 16B.

While the disclosure has been described with respect to a limited number of embodiments, those skilled in the art, having benefit of this disclosure, will appreciate that other embodiments can be envisioned that do not depart from the scope of the disclosure as disclosed herein. Accordingly, the scope of the disclosure shall be limited only by the attached claims.

1. A system, comprising:
at least one time of flight (TOF) ranging sensor; and
a processor coupled to the at least one TOF ranging sensor and being configured to execute an operating system commanded by an input sub-program thereof, execution of the input sub-program causing the processor to:
interpret command motions sensed via the at least one TOF ranging sensor in one of a plurality of command interpretation modes,
generate commands for the operating system based on the interpreted command motions, and
switch among the plurality of command interpretation modes based upon sensing of a mode switch motion via the at least one TOF ranging sensor.

2. The system of claim 1, wherein the first command interpretation mode comprises a position tracking mode; and wherein, when in the position tracking mode, the commands for the operating system command the operating system as if the commands were received from an input device.

3. The system of claim 2, wherein, when in the position tracking mode, the commands command the operating system to move a mouse pointer on a display.

4. The system of claim 2, wherein the second command interpretation mode comprises an action mode; and wherein, when in the action mode, the commands for the operating system command the operation system as if the commands were received from the input device.

5. The system of claim 4, wherein, when in the action mode, the commands command the operating system to register a mouse click.

6. The system of claim 1, wherein a given command motion and the mode switch motion are substantially similar motions performed at respectively different distances from the at least one TOF ranging sensor.

7. The system of claim 1, wherein the at least one TOF ranging sensor comprises a plurality of TOF ranging sensors configured to, in operation, measure distances to an object; wherein the processor is further configured to receive indications of the measured distances from the plurality of TOF ranging sensors and determine at least one inclination of the object in relation to at least one direction based on the received indications of the measured distances; and wherein the processor senses the command motions based upon the determined at least one inclination.

8. The system of claim 7, wherein the processor receives indications of the measured distances from:
at least one TOF ranging sensor of the plurality thereof that defines a first direction, as a distance to the object in the first direction, and from
at least one TOF ranging sensor of the plurality thereof that defines a second direction different than the first direction, as a distance to the object in the second direction;
wherein the processor determines a first inclination based upon the received indication of the distance to the object in the first direction, and a second inclination based upon the received indication of the distance to the object in the second direction; and wherein the processor senses the command motions based upon the determined first and second inclinations.

9. The system of claim 1, wherein the mode switch motion comprises movement of the hand in a gesture.

10. The system of claim 9, wherein the gesture comprises a clockwise or counterclockwise semicircular motion.

11. The system of claim 1, wherein the mode switch motion comprises movement of the hand toward the at least one TOF ranging sensor such that the hand moves within a threshold distance from the at least one TOF ranging sensor, or movement of the hand away from the at least one TOF ranging sensor such that the hand moves out of a threshold distance from the at least one TOF ranging sensor.

12. The system of claim 1, wherein the mode switch motion comprises movement of the hand from outside the sensing range of the at least one TOF ranging sensor to within the sensing range of the at least one TOF ranging sensor from a given direction.

13. The system of claim 1, wherein the mode switch motion comprises stabilization of the hand a given distance from the at least one TOF ranging sensor for a given period of time.

14. The system of claim 1, wherein the sub-program comprises a software implemented input device for the operating system.

15. A system, comprising:
at least one visual based motion sensor; and
a processor coupled to the at least one visual based motion sensor and being configured to execute a program causing the processor to:
detect a first command motion performed by a hand within sensing range of the at least one visual based motion sensor,
generate a first command based upon interpreting the first command motion in a first motion interpretation mode,
detect a mode switch motion performed by the hand within sensing range of the at least one visual based motion sensor,
switch from the first motion interpretation mode to a second motion interpretation mode based upon the mode switch motion,
detect a second command motion performed by the hand within sensing range of the at least one visual based motion sensor, and
generate a second command based upon interpreting the motion in a second motion recognition mode.

16. The system of claim 15, wherein the mode switch motion comprises movement of the hand in a gesture.

17. The system of claim 16, wherein the gesture comprises a clockwise or counterclockwise semicircular motion.

18. The system of claim 15, wherein the mode switch motion comprises movement of the hand toward the at least one visual based motion sensor such that the hand moves within a threshold distance from the at least one visual based motion sensor, or movement of the hand away from the at least one visual based motion sensor such that the hand moves out of a threshold distance from the at least one visual based motion sensor.

19. The system of claim 15, wherein the mode switch motion comprises movement of the hand from outside the sensing range of the at least one visual based motion sensor to within the sensing range of the at least one visual based motion sensor from a given direction.

20. The system of claim 15, wherein the mode switch motion comprises stabilization of the hand a given distance from the at least one visual based motion sensor for a given period of time.

21. The system of claim 15, wherein the first motion recognition mode comprises a gesture recognition mode; and wherein the second motion recognition mode comprises a position tracking mode.

22. The system of claim 21, further comprising a display coupled to the processor; and wherein the second command moves a pointer displayed on the display.

23. The system of claim 22, wherein the first command is unrelated to the moving of the pointer.

24. The system of claim 15, wherein the program comprises a software implemented input device for an operating system; and wherein the first and second commands command the operating system.

25. The system of claim 15, wherein the program comprises an operating system; and wherein the first and second commands command the operating system.

26. A method, comprising:
sensing motions performed by a hand within sensing range of at least one visual based sensor, using a processor coupled to the at least one visual based sensor;
generating commands for an operating system of the processor by interpreting the motions in a first motion interpretation mode or a second motion interpretation mode, based upon the motions being command motions, using the processor; and
switching between the first motion interpretation mode and the second interpretation mode, based upon the motions being mode switching motions, using the processor.

27. The method of claim 26, wherein the first motion recognition mode comprises a gesture recognition mode; and wherein the second motion recognition mode comprises a position tracking mode.

28. The method of claim 27, wherein the commands in the position tracking mode move a pointer displayed on a display.

29. The method of claim 28, wherein the commands in the gesture recognition mode are unrelated to the moving of the pointer.

30. The method of claim 16, wherein the mode switching motion comprises movement of the hand in a gesture.
